(19) United States
(12) Patent Application Publication
(10) Pub. No.: US 2016/0380359 A1
(43) Pub. Date: Dec. 29, 2016

(54) DUAL POLARIZATION ANTENNA

(71) Applicants: Henry Cooper, Temecula, CA (US); Sheng Peng, Temecula, CA (US)

(72) Inventors: Henry Cooper, Temecula, CA (US); Sheng Peng, Temecula, CA (US)

(21) Appl. No.: 14/430,516

(22) PCT Filed: Sep. 23, 2013
(86) PCT No.: PCT/US13/61200

§ 371 Date: Jul. 21, 2015

Related U.S. Application Data
(60) Provisional application No. 61/704,264, filed on Sep. 21, 2012.

(51) Int. Cl. H01Q 13/08; H01Q 1/38

(52) U.S. Cl. CPC H01Q 13/085; H01Q 1/38

(57) ABSTRACT

An antenna having a plurality of antenna elements formed into a conductive layer engaged upon a planar dialectic is disclosed. The plurality of formed elements provide for reception and transmission of RF energy in both horizontal and vertical polarized orientations as well as at angles therebetween.

This application claims priority to U.S. Provisional Patent Application Ser. No. 61/704,264 filed on Sep. 21, 2012, which is included herein in its entirety by this notation thereof.

### BACKGROUND OF THE INVENTION

1. Field of the Invention

The present invention relates to antennas for transmission and reception of radio frequency communications. More particularly, it relates to an antenna element configured for reception and transmission in both horizontal and vertical polarizations. The device is especially well configured for use in environments with high RF reflections which can change or significantly alter the original RF polarization of transmissions.

2. Prior Art

External antennas generally take the form of large cumbersome conic, yagi or monopole type construction and are placed outdoors either on a utility pole or on the rooftop of the building housing the receiver or in an attic or the like of a building. These antennas can be somewhat fragile as they are formed by the combination of a plurality of electrically communicative parts including reflectors and receiving and/or RF transmission elements. Such components and antenna RF transmission and reception elements are conventionally formed of light weight aluminum tubing or copper or the like. The individual elements or antennas themselves conventionally have various lengths to satisfy the transmission and reception RF frequency requirements of the received signals and transmitted signals, and also have dialectic insulators, such as plastic insulators. The receiving elements are generally held in relative position by means of tension or apertures in the insulators. Further, the reflectors and elements being operationally connected together. Most such antennas are adapted to receive and/or transmit on a single polarization scheme for the RF energy they receive and transmit. This is generally because in the field, the antenna is deployed to work in a particular environment, with particular RF transmission and reception schemes.

Many other electronic systems employ antennas for radio frequency communication. Vivaldi type, or horn antennas are a type of planar antenna configured for linear horizontal or vertically polarized RF waves, depending on the orientation of the planar antenna. Alternatively, dual polarization is achieved with such Vivaldi or horn antennas by employing two antenna radiator elements arranged in orthogonal direction that can transmit and receive in both linear such as vertical and horizontal, and also circular polarization orientations.

Horn antennas, also called a Vivaldi horn antenna, are conventionally formed of electrically conductive material positioned on nonconductive planar substrates with metalized surfaces on one or both sides forming the radiator element. They are often called horn antenna because the metalized radiator element, formed by removed conductive material on the substrate surface defines a cavity generally in the form of a horn.

In such a horn style antenna, the widest point is typically called the mouth of the cavity which in turn narrows along a throat region along a curved or slanted narrowing path, until reaching a symmetric slot line. A feedline extends from a terminating edge of the formed antenna to an area of the slot line and passes through the substrate to a tap position to electrically connect to the radiator element.

However, the conventional Vivaldi antenna fails to provide adequate performance characteristics for all desired frequencies, and generally such horn antennas are adapted solely to a single RF polarization scheme since they are metallic surfaces formed on a dielectric substrate for particular installations and for use with particular equipment in the field. As a consequence, when employed for transmission and reception in areas having a high potential for reflection and refraction of incoming and outgoing RF transmissions, conventional planar horn antennas are restricted in their ability to send and receive signals should such a change in polarization occur. This is particularly vexing in installations where the antennas are employed in a plurality of positions, to transmit and receive from monitoring and switching components, such as for example an oil pump installation and storage yard. Or, additionally for example a tank or storage yard for oil or gas or other materials which must be stored under particularly stringent conditions which must be heavily monitored. Employment of horn or slot style antennas to transmit and receive data and instructions for opening and closing components for instance, and be particularly vexing. In an oil storage yard, pressure monitors communicating with a slot or horn antenna, to a node or network reception point, must transmit data encapsulated in RF transmissions, through a multitude of metal containers, pipes, and tanks. Rf energy upon striking such metal structures which are curved, angled, and otherwise not parallel or perpendicular to the source of the transmission, will frequently rebound at a new angle or polarization. If incoming RF communications are sufficiently re-angled or polarized, they will result in loss of data and/or commands reaching their destination or being discerned.

As such there is a continuing unmet need, for a high gain antenna element, which is configured to transmit and receive on a wide band of different frequencies concurrently, with radiated RF energy being in both horizontal and vertical polarizations. As noted, this is especially true in locales which have a high potential for reflection and refraction of RF signals, such as areas with metallic structures which have multiple angles to walls and top surfaces. Such a device should be configured to allow for transmission and reception of RF energy such as continuous monitoring digitized data to and from a transceiver, and should consistently and concurrently accommodate reception of RF signals in either polarization, to maintain continuous communication and monitoring of data and/or commands to and from the installation.

### SUMMARY OF THE INVENTION

The device herein disclosed and described provides a solution to the shortcomings in prior art and achieves the above noted goals through the provision of a single radiator antenna element which is uniquely configured to provide excellent transmission and reception capability at a wide variance in intended frequency bands, concurrently, in either of two polarization schemes.

The radiator element or antenna element of the instant invention is configured of electrically conductive material placed upon a planar dielectric to form an antenna element using printed-circuit or similar technology. The antenna is of two-dimensional construction and is formed of metallic material on a dielectric substrate of such materials as MYLAR, fiberglass, REXLITE, polystyrene, polyamide, TEFLON, fiberglass or any other such material suitable for the purpose intended. While a substantially rigid substrate is preferred, the substrate may be flexible whereby the antenna can be rolled up for storage and unrolled into a planar form for use. Or, in a particularly preferred mode of the device herein, it is formed on a substantially rigid substrate material in the planar configuration thereby allowing for components that both connect and form the resulting rigid antenna structure.

The antenna radiator or element itself, formed on the substrate, can be any suitable electrically conductive material. For example, aluminum, copper, silver, gold, platinum or any other electrical conductive material suitable for the purpose intended. The planar conductive material forming the element is adhered to the substrate by any known technology.

In a particularly preferred embodiment, the antenna radiator element conductive material coating on a first side of the substrate is formed with a non-plated cavity or uncovered surface area. The formed radiator has a plurality of cavities or uncoated sections formed therein in particular dimensions which provide for reception and transmission capabilities in both horizontal and vertical polarized frequencies and thereby insure the constant flow of RF transmission and digital data. Other areas are removed to improve areas of impedance matching.

At least two opposing cavities, beginning with an uncoated or unplated surface area of the substrate on opposing terminating edges of the substrate, form a plurality of cavities having mouths of a horn type radiator element to thereby provide a plurality for the antenna element herein. One edge of the cavity extends substantially perpendicular to an imaginary horizontal line running between the two distal side edges of the substrate and continues substantially into the body portion of the radiator element. The other edge of the cavity extends along a curved path toward the body forming a generally asymmetric horn shaped cavity.

The antenna elements formed have the mouth or widest point between two distal ends of edges forming the cavity which both narrow to a narrowest point opposite the mouth of the cavity. The perpendicular configuration and orientation of the horn shaped portion provides transmission and reception capabilities for horizontal and vertically polarized frequencies.

The widest point of the cavity between the distal ends of each radiator halves, determines the low point for the frequency range of the formed element of the formed antenna on the substrate. The narrowest point at the mouth of the cavity between the two halves determines the highest frequency to which the element is adapted for use. Of course those skilled in the art will realize that by adjusting the widest and narrowest distances of the formed cavity, the element may be adapted to other frequency ranges, and any antenna element which employs two substantially identical arm portions to form a cavity therebetween with maximum and minimum widths is anticipated within the scope of the claimed device herein.

There is also included at least one serpentining cavity formed extending from at least one side edge of the substrate to define a meanderline antenna element section of the formed antenna on the substrate. The meanderline portion of the substrate formed antenna, makes at least one right angled extension into the body of the substrate mounted element herein.

Still further, there is additionally included at least one curvilinear cavity, and preferably two curvilinear cavities in a mirrored configuration extending from an opposite side edge of the substrate to terminating ends. The cavities are formed from two parallel side edges extending in a curved path. The spacing of the side edges, and therefor width of the cavity formed, determines the optimal frequency for which the cavity is adapted for use.

There may also be included one or a plurality of apertures or additional cavities formed in the conductive material which allow for impedance matching to further improve performance characteristics.

On the opposite surface of the substrate from the formed radiator element herein, a feedline is operatively positioned and extends from the area substantially central and passes through the substrate to a tap position to electrically connect with a portion of the radiator element at or near the serpentining cavity extending thereby. An electrical connector may be employed at this tap position for electrical communication of the antenna element to additional circuitry or the like, such coaxial connector or other suitable connector.

In other preferred modes, the antenna device is further engaged to an orthogonally opposed ground plane. The ground plane itself can be any suitable conductive material, as for example, aluminum, copper, silver, gold, platinum or any other electrical conductive material suitable for the purpose intended.

The location and width of the feedline and connection, the size and shape of the cavities of the radiator element, and the cross-sectional area of the cavity, may be of the antenna designers choice for best results for a given use and frequency. However, because the disclosed radiator element performs so well and across the desired bandwidth, the current mode of the radiator element as depicted herein, with the connection point shown, is especially preferred. Of course those skilled in the art will realize that shape of the half-portions and size and shape of the cavity may be adjusted to increase gain in certain frequencies or for other reasons known to the skilled, and any and all such changes or alterations of the depicted radiator element as would occur to those skilled in the art upon reading this disclosure are anticipated within the scope of this invention.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

FIG. 1 shows a front view of a particularly preferred mode of the device depicting the formed device herein having a plurality of individual antenna radiator or antenna elements formed into conductive material on a non-conductive substrate.

FIG. 2 is a rear view of the device showing the feedline operatively engaged.

FIG. 3 is again a front view of the device with the feedline of the rear surface shown as dashed lines.

FIG. 4 shows a front view of a another particularly preferred mode of the device depicting the formed antenna radiator element on a non-conductive substrate and engaged to an orthogonally opposed ground plane.

FIG. 5 is a rear view of the device of FIG. 4 showing the feedline.

FIG. 6 is again a front view of the device of FIG. 4 with the feedline of the rear surface shown as dashed lines.

FIG. 7 shows a top view of the mode of the device of FIG. 4 depicting the ground plane.

### DETAILED DESCRIPTION OF THE PREFERRED EMBODIMENTS OF THE INVENTION

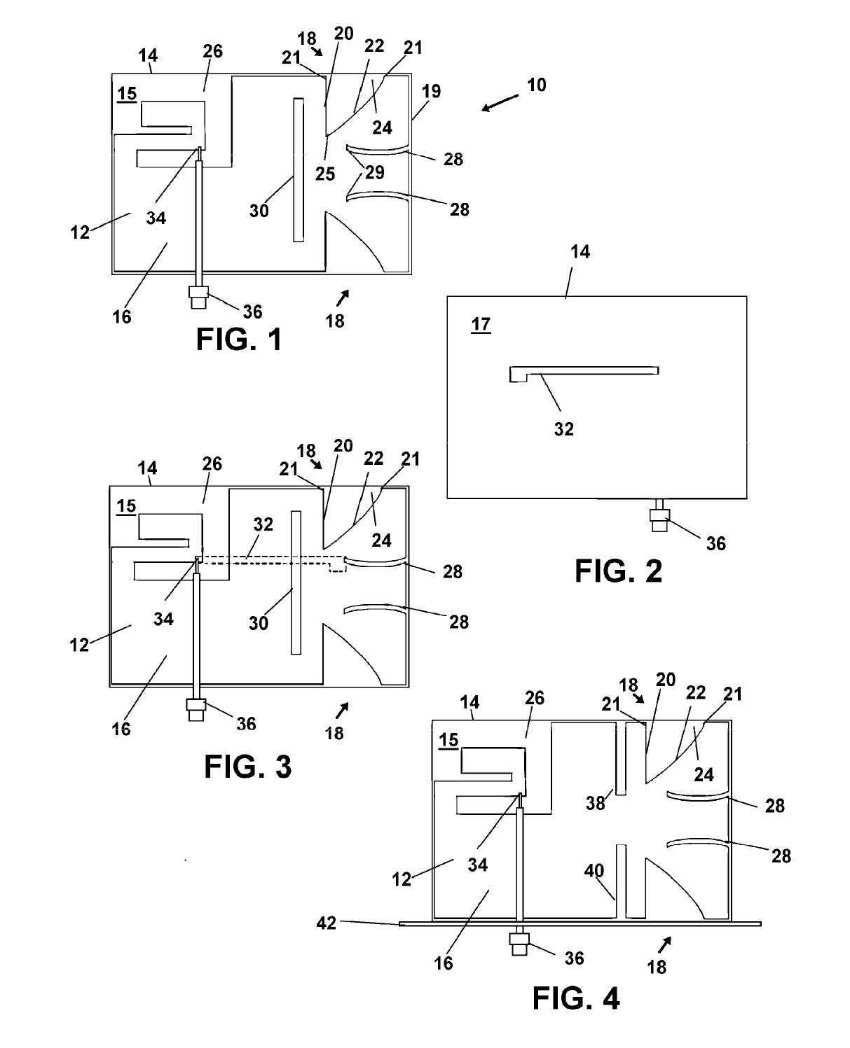

Now referring to drawings in FIGS. 1-7, wherein similar components are identified by like reference numerals, there is seen in FIGS. 1-3, a first particularly preferred mode of the antenna device 10, which is configured for concurrent transmission and reception of RF energy in both horizontal and vertical polarizations. The device 10 includes a plurality of radiator or antenna elements formed on a substrate 14 which as noted is nonconductive and may be constructed of either a rigid or flexible material such as, MYLAR, fiberglass, REXLITE, polystyrene, polyamide, TEFLON fiberglass, or any other such material which would be suitable for the purpose intended.

A first surface 15 is coated with a conductive material by microstripline or the like or other metal and substrate construction well known in this art. Any means for affixing the conductive material to the substrate is acceptable to practice this invention. The conductive material 16 as for example, include but are not limited to aluminum, copper, silver, gold, platinum or any other electrical conductive material which is suitable for the purpose intended.

As shown, the surface conductive material 16 on first surface 15 is etched away, removed by suitable means, or left uncoated in the coating process to form first and second opposing asymmetric horn antenna element portions 18, each having a mouth 24 leading to a terminating end 25. A third antenna element portion is provided by formation of a serpentining cavity 26 defining a meanderline antenna portion, and one or a plurality of mirrored curvilinear cavities 28, providing fourth and fifth antenna elements to the formed antenna device 10. Additional apertures 30 or notches 38,40 are also formed as needed for impedance matching and improving performance characteristics.

The horn shaped cavity portions 18 defining the first and second antenna elements of the device 10 each has a widest point extending from the mouth 24 between the distal endpoints 21 of the two side edges 20, 22 to a narrowest point at the terminating end 25 of the cavity 18.

Particularly preferred, a first edge 20 providing vertical polarization reception for RF in each cavity 18, extends substantially linearly and perpendicular to an imaginary horizontal line running between the two side edges of the substrate 14 and continues substantially into the body portion of the radiator element 12. This linear formation to the cavity allows for the vertical and horizontal polarization schemes, as well as reception along angular lines with the curved side edge and horizontal lines therewith. Without the linear first edge 20 such would not be possible.

The second side edge 22 of the cavity 18 opposite the linear first edge 20, extends along a curved path toward the body forming a generally asymmetric horn shaped cavity 18. The length of the straight first edge 20 defines the sweet spot for the frequency in the horizontal or vertical disposition depending upon the orientation of the device 10 which is shown in the preferred orientation.

The widest distance between the distal ends 21 determines the low point for the frequency range of the device 10. The narrowest distance of the mouth 24 portion of the cavity 18 determines the highest frequency to which the device 10 is adapted for use. Of course those skilled in the art will realize that by adjusting the widest and narrowest distances of the formed cavity, the element may be adapted to other frequency ranges, and any antenna element which employs two substantially identical leaf portions to form a cavity therebetween with maximum and minimum widths is anticipated within the scope of the claimed device herein.

There is also included at least one serpentining cavity 26 formed extending from at least one side edge of the substrate 14 and making are least one right angled extension into the body of the radiator element 12. This defines a third antenna element formed in the structure of the device 10. Those skilled in the art will recognize the performance characteristics of such a serpentining cavity 26 extending as shown in the figure.

Still further, there is additionally included at least one, but preferably two, curvilinear cavities 28 in a mirrored configuration extending from a side edge 19 of the substrate 14 to terminating ends 29. The cavities are formed from two parallel side edges extending in a curved path. The spacing of the side edges, and therefor width of the cavity 28 determines the frequency for which the cavity 28 is adapted for use. The curved orientation allows for the reception of RF signals which have reflected at angles other than vertically polarized for the device 10 shown in the preferred orientation.

There may also be included one or a plurality of apertures, such as the elongated aperture 30 shown, or additional cavities formed in the conductive material 16 which allow for impedance matching to further improve performance characteristics of the device 10.

On the opposite surface 17 of the substrate 14 shown in FIG. 2, a feedline 32 extends to an area adjacent an end 29 of a curvilineal cavity 28 to a portion of the conductive material 16 at or near the serpentining cavity 26. An electrical connector 36 is further shown engaged at a tap position 34 of the feedline 32 as needed to engaged the device 10 to transmission lines, additional circuitry, or the like as is commonly known in the art.

FIG. 3 shows again the front view of the device 10 with the feedline 32 of the opposite surface 17 shown in dashed lines better detailing the location and orientation.

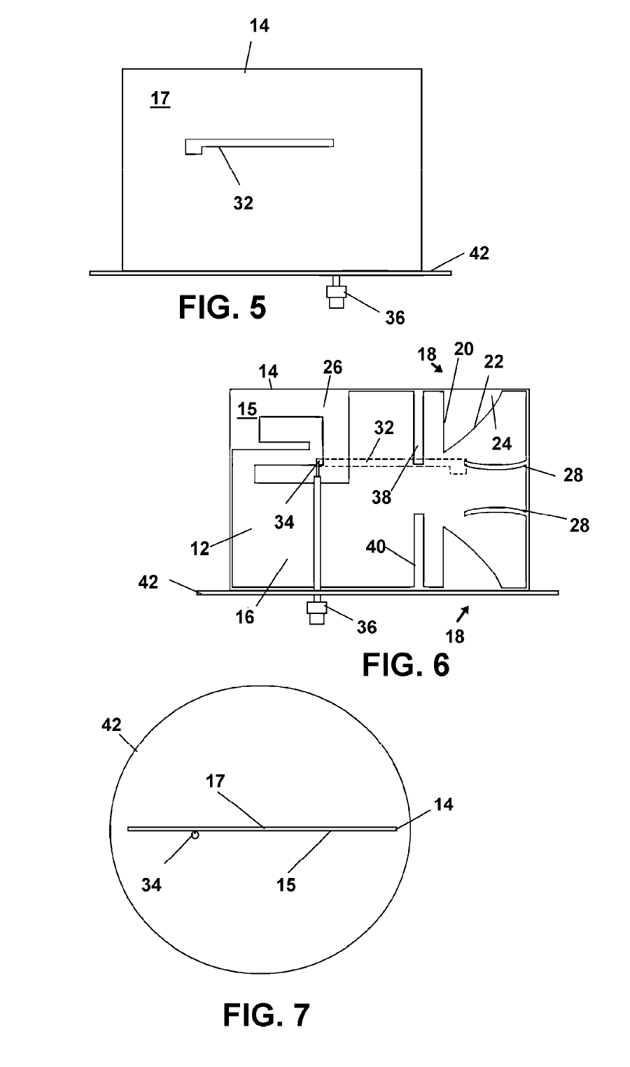

FIG. 4, FIG. 5, FIG. 6, and FIG. 7 show views of anther particularly preferred mode of the device 10 engaged to an orthogonally opposed ground plane 42 situated with the device 10 in the preferred orientation. The ground plane 42 provides for improved performance characteristics for gain and distance of transmission and reception, as well as related impedance matching, and other characteristics which may be recognized by those skilled in the art. The ground plane 42 can be any suitable conductive material, as for example, aluminum, copper, silver, gold, platinum or any other electrical conductive material suitable for the purpose intended. In other modes, however, the ground plane 42 can similarly be formed of an engaged layer of conductive material to a non conductive substrate which is operatively engaged to the radiator element 12 of the device 10. Further, as can be seen, the device 10 in the current mode employs a plurality of opposing notch portions 38, 40 employed to improve in impedance matching.

As depicted in the figures, the device 10 in the preferred orientation, would be employed in a substantially vertical disposition with both the dielectric material and radiator element 12 thereon, perpendicular to the earth. In this configuration, the device 10 is able to transmit and receive RF energy at the same frequency or varied frequencies, in both horizontal and vertical polarizations, as wells as angled orientations therebetween due to the linear and curved sidewalls of the formed cavities.

The resulting antenna element is especially well configured for the transmission and reception of data from electronic sensors positioned to monitor manufacturing or storage areas with many metal angled housings such as an oil storage facility. Such structures conventionally have round and square metal structures which will continually reflect and change the polarization of RF energy transmitted by multiple sensors and transceivers communicating data to a server.

Because the antenna element in a vertical disposition will easily receive and transmit RF signals in either polarization, the device allows a method of a monitoring infrastructure, having multiple electronic monitoring components with transceivers, which continuously transmit data to a server and to each other, as to what is being monitored by a sensor. Should transmissions be changed in polarization, the disclosed antenna will easily continue to receive such and communicate discernable signals to a connected transceiver to which the signal containing data is directed.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. An antenna element, comprising:
a planar dialectic material having opposing first and second sides;
a rectangular planar conductive material operatively engaged to one of said two sides;
said planar conductive material having a preferred vertical orientation having a first horizontal edge and parallel second horizontal edge spaced therefrom;
first and second side edges vertically disposed between said first and second horizontal edges;
a first cavity formed in said conductive material, said first cavity having a mouth portion extending between two points along said second horizontal edge;
a first side edge of said first cavity extending in a line from one side of said mouth substantially parallel to said first and second side edges;
a second side edge of said first cavity extending in curved line from an opposite side of said mouth as said first side edge;
said first and second side edges defining a said cavity declining in cross section from a widest point at said mouth;
a second cavity formed in said conductive material, said second cavity having a mouth portion extending between two points along one of said side edges;
a first side edge of said second cavity extending in a line from one side of said mouth substantially perpendicular to said first side edge of said first cavity;
a second side edge of said second cavity extending in curved line from an opposite side of said mouth as said first side edge of said second cavity;
said first and second side edges said cavity as declining in cross section from a widest point at said mouth thereof; and
a feed line operatively engaged with said conductive material whereby RF signals may be received by said antenna element in horizontal and vertical polarizations, and at angles therebetween between respective first and second side edges of said first and second cavities.

2. The antenna element of claim 1 additionally comprising:
a serpentine cavity formed in said conductive material extending from at least one of said side edges;
said serpentine cavity defining a meanderline antenna element of said antenna element.

3. The antenna element of claim 1 additionally comprising:
two curvilinear cavities in a mirrored configuration extending from a side edge of said conductive material;
both said curvilineal cavities defined by two parallel side edges extending in a curved path; and
said parallel side edges of each respective side edge separated from the respective other by a distance, said distance defining an RF frequency for reception by a third antenna and fourth antenna element formed by said curvilineal cavities.

4. The antenna element of claim 2 additionally comprising:
two curvilinear cavities in a mirrored configuration extending from a side edge of said conductive material;
both said curvilineal cavities defined by two parallel side edges extending in a curved path; and
said parallel side edges of each respective side edge separated from the respective other by a distance, said distance defining an RF frequency for reception by a third antenna and fourth antenna element formed by said curvilineal cavities.

5. The antenna element of claim 1 additionally comprising:
a planar ground plane formed by said conductive material running in a plane normal to an adjacently positioned first horizontal edge.

6. The antenna element of claim 2 additionally comprising:
a planar ground plane formed by said conductive material running in a plane normal to an adjacently positioned first horizontal edge.

7. The antenna element of claim 3 additionally comprising:
a planar ground plane formed by said conductive material running in a plane normal to an adjacently positioned first horizontal edge.

8. The antenna element of claim 4 additionally comprising:
a planar ground plane formed by said conductive material running in a plane normal to an adjacently positioned first horizontal edge.
